(19) United States
(12) Patent Application Publication
(10) Pub. No.: US 2017/0108921 A1
(43) Pub. Date: Apr. 20, 2017

(54) ELECTRONIC MAP DISPLAYING METHOD, APPARATUS, AND VEHICULAR DEVICE

(71) Applicant: Beijing Zhigu Rui Tuo Tech Co., Ltd., Beijing (CN)

(72) Inventor: Zhengxiang Wang, Beijing (CN)

(21) Appl. No.: 15/267,229

(22) Filed: Sep. 16, 2016

(30) Foreign Application Priority Data
Oct. 16, 2015 (CN) 201510674069.7

(51) Int. Cl. G06F 3/01; G06F 3/0482; G01C 21/36; G06F 3/0481

(52) U.S. Cl. CPC G06F 3/013; G06F 3/04817; G06F 3/0482; G01C 21/367

(57) ABSTRACT

Embodiments of the present application provide an electronic map displaying method and apparatus, and a vehicular terminal. The method comprises: determining at least one entity at which a user is gazing; determining, according to at least the at least one entity, at least one map object type to which the user is paying attention; and displaying emphatically, on an electronic map, information of at least one object matching the at least one map object type. The embodiments of the present application provide an electronic map displaying solution.

### TECHNICAL FIELD

Embodiments of the present application relate to the field of interaction technologies, and in particular, to an electronic map displaying method and apparatus, and a vehicular device.

### BACKGROUND

An existing electronic map usually displays same content for a same area on a same scale. However, a user may intend to view different content on the map in different needs, for example, intend to view positions of roads to a destination on the map when travelling, intend to view positions of restaurants on the map when dining out, intend to view positions of park attractions when going on a tour, and intend to view positions of markets on the map when going shopping.

### SUMMARY

In view of this, an objective of embodiments of the present application is to provide an electronic map displaying solution.

To implement the foregoing objective, according to a first aspect of the embodiments of the present application, an electronic map displaying method is provided, comprising:

determining at least one entity at which a user is gazing;

determining, according to at least the at least one entity, at least one map object type to which the user is paying attention; and

displaying emphatically, on an electronic map, information of at least one object matching the at least one map object type.

To implement the foregoing objective, according to a second aspect of the embodiments of the present application, an electronic map displaying apparatus is provided, comprising:

a first determining unit, configured to determine at least one entity at which a user is gazing;

a second determining unit, configured to determine, according to at least the at least one entity, at least one map object type to which the user is paying attention; and

a displaying unit, configured to display emphatically, on an electronic map, information of at least one object matching the at least one map object type.

To implement the foregoing objective, according to a third aspect of the embodiments of the present application, a vehicular device is provided, comprising:

an eye-tracking module group, configured to track eyes of a user;

a memory, configured to store instructions; and

a processor, configured to execute the instructions stored in the memory, wherein the instructions cause the processor to execute the following operations:

determining, according to at least a tracking result of the eye-tracking module group, at least one entity at which the user is gazing;

determining, according to at least the at least one entity, at least one map object type to which the user is paying attention; and

displaying emphatically, on an electronic map, information of at least one object matching the at least one map object type.

At least one technical solution in the foregoing technical solutions has the following beneficial effects:

According to the embodiments of the present application, at least one entity at which a user is gazing is determined, at least one map object type to which the user is paying attention is determined according to at least the at least one entity, and information of at least one object matching the at least one map object type is displayed emphatically on an electronic map. Thereby, an electronic map displaying solution is provided. Specifically, a map object type that a user is interested in is predicted by using at least one entity at which the user is gazing and a corresponding object is displayed emphatically, without the need for the user to manually select an interested map object type, which is relatively convenient, and is safer for a user driving a vehicle.

### BRIEF DESCRIPTION OF THE DRAWINGS

FIG. 1 is a schematic flowchart according to an embodiment of an electronic map displaying method provided in the present application;

FIG. 2A and FIG. 2B are respectively schematic diagrams of a same displayed area on an electronic map when at least one map object type is restaurant and bank respectively.

FIG. 3A is a schematic structural diagram according to a first embodiment of an electronic map displaying apparatus provided in the present application;

FIG. 3B is a schematic structural diagram according to an implementation of the embodiment shown in FIG. 3A;

FIG. 4 is a schematic structural diagram according to a second embodiment of an electronic map displaying apparatus provided in the present application;

FIG. 5A is a schematic structural diagram according to an embodiment of a vehicular device provided in the present application; and

FIG. 5B is a schematic structural diagram according to an implementation of the embodiment shown in FIG. 5A.

### DETAILED DESCRIPTION

Specific implementations of the present application are described in further detail below with reference to the accompanying drawings and embodiments. The following embodiments are intended to describe the present application, but not to limit the scope of the present application.

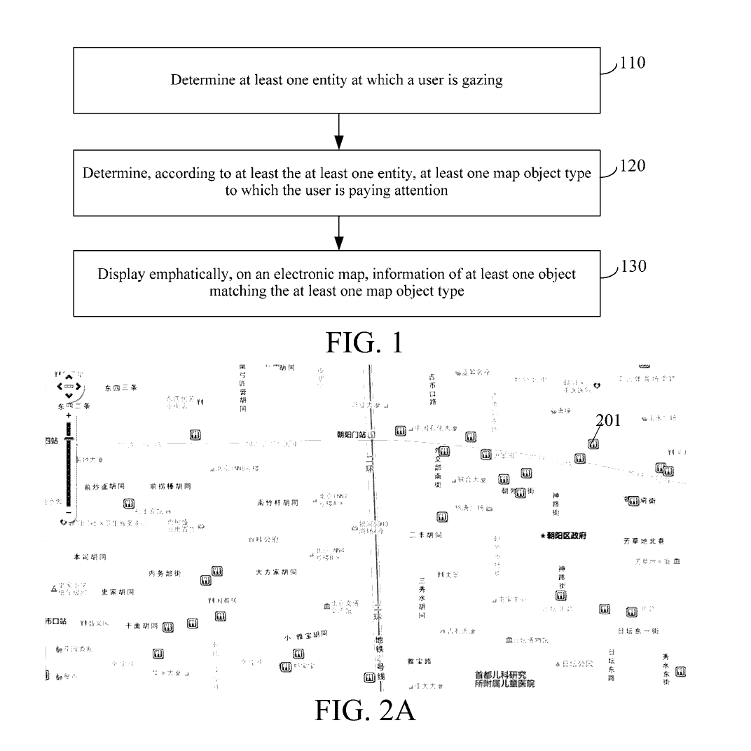

FIG. 1 is a schematic flowchart according to an embodiment of an electronic map displaying method provided in the present application. As shown in FIG. 1, this embodiment comprises:

110. Determine at least one entity at which a user is gazing.

For example, an electronic map displaying apparatus according to a first embodiment or a second embodiment of an electronic map displaying apparatus provided in the present application, or a vehicular device according to an embodiment of a vehicular device provided in the present application acts as an execution body in this embodiment to perform 110 to 130.

In this embodiment, an entity is an object in real existence in the objective world. Specifically, the at least one entity is optionally one entity or multiple entities.

In this embodiment, there may exist multiple manners for determining which entity or entities at which the user is gazing. For example, a gazing point of the user is determined by using an eye tracking technology, an image at the gazing point is acquired, and the image is analyzed to determine which entity or entities at which the user is gazing.

In this embodiment, the at least one entity is generally located in a visible range of the user. In a possible scenario, the user is in a vehicle, and the at least one entity is optionally located outside of the vehicle, for example, the at least one entity comprises but not limited to a road sign, a building, and a roadside attraction.

120. Determine, according to at least the at least one entity, at least one map object type to which the user is paying attention.

In this embodiment, the at least one map object type is related to the at least one entity, and the at least one entity represents which type or types of objects on an electronic map that the user may be interested in. Specifically, the at least one map object type is optionally one map object type or multiple map object types.

130. Display emphatically, on an electronic map, information of at least one object matching the at least one map object type.

In this embodiment, the at least one object is at least one object on the electronic map. Specifically, the at least one object is optionally one object or multiple objects.

In this embodiment, each map object type of the at least one map object type may match one object or multiple objects on the electronic map. Specifically, each object matching a map object type is of the map object type. For example, the at least one map object type comprises but not limited to at least one of the following: road mark, restaurant, bank, hotel, market, store, hospital, pharmacy, post office, scenic spot, office building, bus stop, gas station, and parking lot. Correspondingly, at least one object matching the map object type, road mark, comprises but not limited to: A, traffic lights at a crossing, B, an interchange, and C, a landmark building, and at least one object matching the map object type, restaurant, comprises but not limited to: D, a restaurant, E, a snack bar, and F, a fast food restaurant.

In this embodiment, information of any object of the at least one object optionally comprises but not limited to any one of the following: a name, a graph, a type icon, and an attribute description. For example, for a road, a name may be “Xiaoying West Road”, a graph may comprise lines and colors for describing the road on the electronic map, an attribute description may comprise information such as a quantity of lanes of the road and a congestion status of the road; and for a market, a name may be “Chongguang Department Store”, a graph may comprise lines and colors for describing the market on the electronic map, a type icon may be an icon for identifying a market type on the electronic map, and an attribute description may be discount information of the market.

In this embodiment, displaying emphatically, on an electronic map, information of at least one object matching the at least one map object type is equivalent to displaying emphatically, in a currently displayed area on the electronic map, information of at least one object matching the at least one map object type.

In this embodiment, displaying emphatically, on an electronic map, information of at least one object matching the at least one map object type is to display emphatically the at least one object on the electronic map.

According to this embodiment, at least one entity at which a user is gazing is determined, at least one map object type to which the user is paying attention is determined according to at least the at least one entity, and information of at least one object matching the at least one map object type is displayed emphatically on an electronic map. Thereby, an electronic map displaying solution is provided. Specifically, a map object type that a user is interested in is predicted by using at least one entity at which the user is gazing and a corresponding object is displayed emphatically, without the need for the user to manually select an interested map object type, which is relatively convenient, and is safer for a user driving a vehicle.

The method according to this embodiment is further described below by using some optional implementations.

In this embodiment, multiple implementations exist for 110.

In a process in which the user continuously searches for a point of interest with eyes, a gazing point of the user may continuously change. To learn a point of interest of the user more accurately, in an optional implementation, the determining at least one entity at which a user is gazing comprises:

determining at least one entity at which the user is gazing for a duration exceeding a threshold in a time period.

A time length of the time period may be preset, for example, to 2 minutes or 10 minutes.

The gazing duration is equivalent to a sight focusing duration, and the threshold may be preset, for example, to 5 seconds or 10 seconds.

In this embodiment, multiple implementations exist for 120.

In an optional implementation, the determining, according to at least the at least one entity, at least one map object type to which the user is paying attention comprises:

determining, according to at least the at least one entity, at least one map object type corresponding to the at least one entity; and

determining, according to at least the at least one map object type corresponding to the at least one entity, the at least one map object type to which the user is paying attention.

The at least one map object type corresponding to the at least one entity is a collection of at least one map object type corresponding to each entity of the at least one entity.

For example, the at least one entity comprises two entities, where one entity is a restaurant, and it is determined that at least one map object type corresponding to the entity is restaurant; the other entity is a landmark office building, and it is determined that at least one map object type corresponding to the entity comprises road mark and office building; and correspondingly, the at least one map object type corresponding to the at least one entity comprises restaurant, road mark, and office building.

It is to be noted that, in the at least one entity, there may exist at least one entity that is not corresponding to any map object type, for example, an automobile dashboard and a roadside railing, and correspondingly, such entities are not considered when the at least one map object type corresponding to the at least one entity is determined.

Multiple implementations exist for determining, according to at least the at least one map object type corresponding to the at least one entity, the at least one map object type to which the user is paying attention.

Optionally, the determining, according to at least the at least one map object type corresponding to the at least one entity, the at least one map object type to which the user is paying attention comprises:

determining that the at least one map object type to which the user is paying attention is the at least one map object type corresponding to the at least one entity.

Optionally, the at least one map object type corresponding to the at least one entity is multiple map object types; and the determining, according to at least the at least one map object type corresponding to the at least one entity, the at least one map object type to which the user is paying attention comprises:

determining that the at least one map object type to which the user is paying attention is at least one map object type for which a quantity of corresponding gazed-at entities is the greatest in the multiple map object types.

The at least one map object type for which a quantity of corresponding gazed-at entities is the greatest is optionally one map object type or multiple map object types.

For example, the at least one entity determined in 110 is 10 entities denoted as S1 to S10. At least one map object type corresponding to the 10 entities comprises restaurant, road mark, and office building, where gazed-at entities corresponding to the map object type, restaurant, is S1, S2, and S3, gazed-at entities corresponding to the map object type, road mark, is S3, S4, S5, S6, and S7, and gazed-at entities corresponding to the map object type, office building, is S7, S8, S9, and S10. It can be seen that, a quantity of gazed-at entities corresponding to the map object type, road mark, is the greatest, and therefore, the at least one map object type to which the user is paying attention is road mark.

In addition to the foregoing two implementations in multiple implementations for determining, according to at least the at least one map object type corresponding to the at least one entity, the at least one map object type to which the user is paying attention, other optional implementations also exist. For example, it is determined that the at least one map object type to which the user is paying attention is at least one map object type, in the multiple map object types, for which a quantity of corresponding gazed-at entities exceeds a quantity threshold, or it is determined that the at least one map object type to which the user is paying attention is at least one map object type, in the multiple map object types, for which a quantity of corresponding gazed-at entities ranks before a preset order. The other optional implementations are not enumerated herein.

In this embodiment, multiple emphasizing manners exist for the emphatically displaying in 130, that is, multiple implementations exist for 130.

In an optional implementation, the displaying emphatically, on an electronic map, information of at least one object matching the at least one map object type comprises:

displaying information of at least one object on the electronic map that matches the at least one map object type, without displaying information of any other object.

That is, information of at least one object, in a currently displayed area on the electronic map, that matches the at least one map object type is displayed, and information of any other object in the currently displayed area on the electronic map is not displayed. The at least one object matching the at least one map object type may be all objects in the currently displayed area that match the at least one map object type, or a part of objects in the currently displayed area that match the at least one map object type. In addition, when the at least one map object type is multiple map object types, for each map object type, different quantities or different proportions of objects may be selected from all objects matching the map object type in the currently displayed area to display information of the objects. Further optionally, a proportion among quantities of objects selected from all objects matching the map object types in the currently displayed area matches a proportion among quantities of entities, in the at least one entity determined in 110, corresponding to each map object type. For example, the at least one entity determined in 110 is 10 entities, where at least one map object type corresponding to the 10 entities comprises restaurant, road mark, office building, bank, and store. The at least one map object type to which the user is paying attention determined in 120 is map object types ranking in the top three, restaurant, road mark, and office building, where a quantity of gazed-at entities corresponding to the map object type, restaurant, is 5, a quantity of gazed-at entities corresponding to the map object type, road mark, is 4, and a quantity of gazed-at entities corresponding to the map object type, office building, is 3. Optionally, information of a objects matching the map object type, restaurant, information of b objects matching the map object type, road mark, and information of c objects matching the map object type, office building, are displayed in 130, and a:b:c=5:4:3.

The other objects are objects that do not match the at least one map object type.

For example, if the at least one map object type is road mark, information of at least one object matching the map object type, road mark, on the electronic map is displayed, and information of any object that does not match the map object type, road mark, is not displayed. Further, if the information is a name, a name of at least one object matching the map object type, road mark, on the electronic map is displayed, and a name of any object that does not match the map object type, road mark, is not displayed.

It is to be noted that, when the information is a name, that information of the any other object is not displayed above merely means that a name of the any other object is not displayed, and whether other information such as a graph or a type icon of the any other object is displayed is not limited.

In another optional implementation, the displaying emphatically, on an electronic map, information of at least one object matching the at least one map object type comprises:

displaying information of all objects on the electronic map that match the at least one map object type, and displaying information of a part of other objects.

That is, information of all objects, in a currently displayed area on the electronic map, that match the at least one map object type is displayed, and information of a part of other objects, in the currently displayed area on the electronic map, that do not match the at least one map object type is displayed.

The other objects are objects that do not match the at least one map object type.

“All” is used in respective of a quantity of objects that match the at least one map object type, and “a part of” is used in respective of a quantity of objects that do not match the at least one map object type. On one hand, a proportion of a part of other objects in all other objects may be preset, or is determined according to actual distributions of other objects and the at least one object in a currently displayed area on the electronic map. On the other hand, information of which part of the other objects is specifically displayed may be determined according to priorities of the other objects or may be determined according to map layers in which the other objects are located. For example, a currently displayed area on the electronic map comprises 10 objects that match the at least one map object type and 10 other objects that do not match the at least one map object type, and correspondingly, information of the 10 objects is displayed, and information of a part of objects in the 10 other objects is displayed, for example, information of 5 of the other objects is displayed and information of the other 5 of the other objects is not displayed. Further, if the information is a name, names of the 10 objects on the electronic map are displayed, and names of the 5 other objects on the electronic map are displayed, and names of the other 5 other objects are not displayed.

FIG. 2A and FIG. 2B are respectively schematic diagrams of a same displayed area on an electronic map when at least one map object type is restaurant and bank respectively. In FIG. 2A and FIG. 2B, the information are both a type icon. An icon 201 consisting of a knife and a pork in FIG. 2A is a type icon for a restaurant. It can be seen that, a quantity of icons 201 in FIG. 2A is significantly greater than those of other types of type icons. An icon 202 that is a sign “¥” in FIG. 2B is a type icon for a bank. It can be seen that, a quantity of icons 202 in FIG. 2B is significantly greater than those of other types of type icons.

In still another optional implementation, the displaying emphatically, on an electronic map, information of at least one object matching the at least one map object type comprises:

displaying, in an enhancement mode, information of at least one object on the electronic map that matches the at least one map object type, and displaying information of at least one of other objects in a normal mode.

That is, information of at least one object, in a currently displayed area on the electronic map, that matches the at least one map object type is displayed in an enhancement mode, and information of at least one of other objects in the currently displayed area on the electronic map is displayed in a normal mode.

The other objects are objects that do not match the at least one map object type.

In this implementation, optionally, the enhancement mode comprises but not limited to either one of the following: an enlargement mode and a highlight mode. For example, if the at least one map object type is road mark and the enhancement mode comprises an enlargement mode, information of at least one object matching the map object type, road mark, on the electronic map, is displayed enlarged, and information of any object that does not match the map object type, road mark, is displayed in a normal size. Further, if the information is a name, a name of at least one object matching the map object type, road mark, on the electronic map, is displayed enlarged, and a name of any object that does not match the map object type, road mark, is displayed in a normal size.

It is to be noted that, in addition to the foregoing three implementations, many other optional implementations for 130 also exist, for example, an implementation combining all vs. partial and enhancement mode vs. normal mode, which are not enumerated herein.

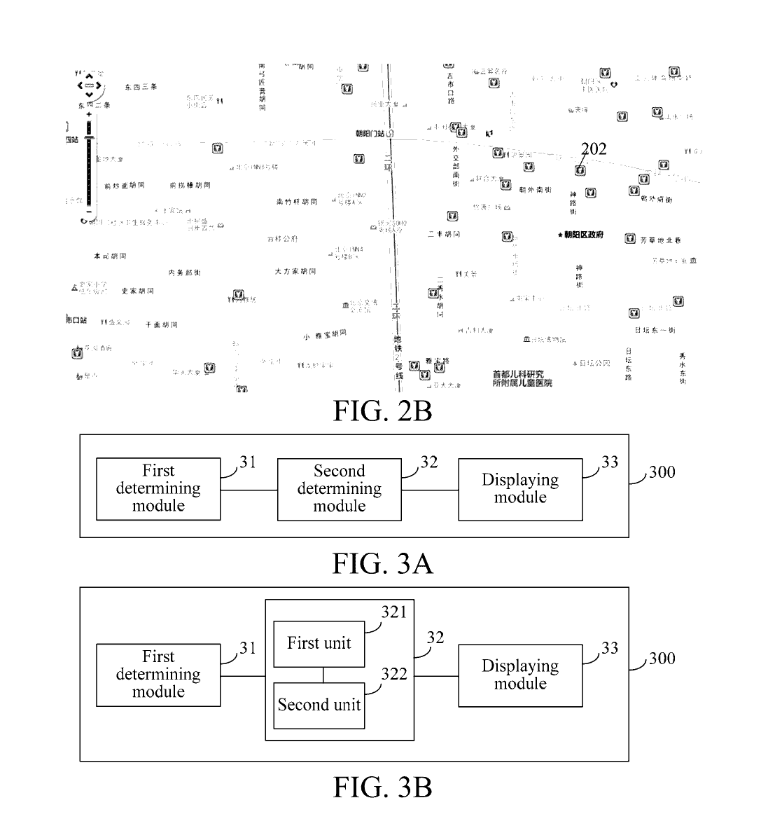

FIG. 3A is a schematic structural diagram according to a first embodiment of an electronic map displaying apparatus provided in the present application. As shown in FIG. 3A, the electronic map displaying apparatus (briefly referred to as apparatus hereafter) 300 comprises:

a first determining module 31, configured to determine at least one entity at which a user is gazing;

a second determining module 32, configured to determine, according to at least the at least one entity, at least one map object type to which the user is paying attention; and

a displaying module 33, configured to display emphatically, on an electronic map, information of at least one object matching the at least one map object type.

In this embodiment, an entity is an object in real existence in the objective world. Specifically, the at least one entity is optionally one entity or multiple entities.

In this embodiment, multiple manners exist for the first determining module 31 to determine which entity or entities at which the user is gazing. For example, a gazing point of the user is determined by using an eye tracking technology, an image at the gazing point is acquired, and the image is analyzed to determine which entity or entities at which the user is gazing.

In this embodiment, the at least one entity is generally located in a visible range of the user. In a possible scenario, the user is in a vehicle, and the at least one entity is optionally located outside of the vehicle, for example, the at least one entity comprises but not limited to a road sign, a building, and a roadside attraction.

In this embodiment, the at least one map object type is related to the at least one entity, and the at least one entity represents which type or types of objects on an electronic map that the user may be interested in. Specifically, the at least one map object type is optionally one map object type or multiple map object types.

In this embodiment, the at least one object is at least one object on the electronic map. Specifically, the at least one object is optionally one object or multiple objects.

In this embodiment, each map object type of the at least one map object type may match one object or multiple objects on the electronic map. Specifically, each object matching a map object type is of the map object type. For example, the at least one map object type comprises but not limited to at least one of the following: road mark, restaurant, bank, hotel, market, store, hospital, pharmacy, post office, scenic spot, office building, bus stop, gas station, and parking lot. Correspondingly, at least one object matching the map object type, road mark, comprises but not limited to: A, traffic lights at a crossing, B, an interchange, and C, a landmark building, and at least one object matching the map object type, restaurant, comprises but not limited to: D, a restaurant, E, a snack bar, and F, a fast food restaurant.

In this embodiment, information of any object of the at least one object optionally comprises but not limited to any one of the following: a name, a graph, a type icon, and an attribute description. For example, for a road, a name may be “Xiaoying West Road”, a graph may comprise lines and colors for describing the road on the electronic map, an attribute description may comprise information such as a quantity of lanes of the road and a congestion status of the road; and for a market, a name may be “Chongguang Department Store”, a graph may comprise lines and colors for describing the market on the electronic map, a type icon may be an icon for identifying a market type on the electronic map, and an attribute description may be discount information of the market.

In this embodiment, displaying emphatically, by the displaying module 33 on an electronic map, information of at least one object matching the at least one map object type is equivalent to displaying emphatically, by the displaying module 33 in a currently displayed area on the electronic map, information of at least one object matching the at least one map object type.

In this embodiment, displaying emphatically, by the displaying module 33 on an electronic map, information of at least one object matching the at least one map object type is to display emphatically the at least one object on the electronic map.

According to the electronic map displaying apparatus in this embodiment, a first determining module determines at least one entity at which a user is gazing, a second determining module determines, according to at least the at least one entity, at least one map object type to which the user is paying attention, and a displaying module displays emphatically, on an electronic map, information of at least one object matching the at least one map object type. Thereby, an electronic map displaying solution is provided. Specifically, a map object type that a user is interested in is predicted by using at least one entity at which the user is gazing and a corresponding object is displayed emphatically, without the need for the user to manually select an interested map object type, which is relatively convenient, and is safer for a user driving a vehicle.

The electronic map displaying apparatus 300 according to this embodiment is further described below by using some optional implementations.

In this embodiment, multiple implementations exist for the first determining module 31.

In a process in which the user continuously searches for a point of interest with eyes, a gazing point of the user may continuously change. To learn a point of interest of the user more accurately, in an optional implementation, the first determining module 31 is specifically configured to determine at least one entity at which the user is gazing for a duration exceeding a threshold in a time period.

A time length of the time period may be preset, for example, to 2 minutes or 10 minutes.

The gazing duration is equivalent to a sight focusing duration, and the threshold may be preset, for example, to 5 seconds or 10 seconds.

In this embodiment, multiple implementations exist for the second determining module 32.

In a first optional implementation, as shown in FIG. 3B, the second determining module 32 comprises:

a first unit 321, configured to determine, according to at least the at least one entity, at least one map object type corresponding to the at least one entity; and

a second unit 322, configured to determine, according to at least the at least one map object type corresponding to the at least one entity, the at least one map object type to which the user is paying attention.

The at least one map object type corresponding to the at least one entity is a collection of at least one map object type corresponding to each entity of the at least one entity.

For example, the at least one entity comprises two entities, where one entity is a restaurant, and the first unit 321 determines that at least one map object type corresponding to the entity is restaurant; the other entity is a landmark office building, and the first unit 321 determines that at least one map object type corresponding to the entity comprises road mark and office building; and correspondingly, the first unit 321 determines that the at least one map object type corresponding to the at least one entity comprises restaurant, road mark, and office building.

It is to be noted that, in the at least one entity, there may exist at least one entity that is not corresponding to any map object type, for example, an automobile dashboard and a roadside railing, and correspondingly, such entities are not considered when the first unit 321 determines the at least one map object type corresponding to the at least one entity.

Multiple implementation manners exist for the second unit 322.

Optionally, the second unit 322 is specifically configured to:

determine that the at least one map object type to which the user is paying attention is the at least one map object type corresponding to the at least one entity.

Optionally, the at least one map object type corresponding to the at least one entity is multiple map object types; and the second unit 322 is specifically configured to:

determine that the at least one map object type to which the user is paying attention is at least one map object type for which a quantity of corresponding gazed-at entities is the greatest in the multiple map object types.

The at least one map object type for which a quantity of corresponding gazed-at entities is the greatest is optionally one map object type or multiple map object types.

For example, the at least one entity determined by the first determining module 31 is 10 entities denoted as S1 to S10. The first unit 321 determines that at least one map object type corresponding to the 10 entities comprises restaurant, road mark, and office building, where gazed-at entities corresponding to the map object type, restaurant, is S1, S2, and S3, gazed-at entities corresponding to the map object type, road mark, is S3, S4, S5, S6, and S7, and gazed-at entities corresponding to the map object type, office building, is S7, S8, S9, and S10. It can be seen that, a quantity of gazed-at entities corresponding to the map object type, road mark, is the greatest, and therefore, the second unit 322 determines that the at least one map object type to which the user is paying attention is road mark.

In addition to the foregoing two implementations, other optional implementations also exist for the second unit 322. For example, the second unit 322 is specifically configured to determine that the at least one map object type to which the user is paying attention is at least one map object type, in the multiple map object types, for which a quantity of corresponding gazed-at entities exceeds a quantity threshold, or the second unit 322 is specifically configured to determine that the at least one map object type to which the user is paying attention is at least one map object type, in the multiple map object types, for which a quantity of corresponding gazed-at entities ranks before a preset order. The other optional implementations are not enumerated herein.

In this embodiment, multiple emphasizing manners exist for the emphatically displaying by the displaying module 33, that is, multiple implementations exist for the displaying module 33.

In an optional implementation, the displaying module 33 is specifically configured to:

display information of at least one object on the electronic map that matches the at least one map object type, without displaying information of any other object.

That is, the displaying module 33 displays information of at least one object, in a currently displayed area on the electronic map, that matches the at least one map object type, and does not display information of any other object in the currently displayed area on the electronic map. The at least one object matching the at least one map object type may be all objects in the currently displayed area that match the at least one map object type, or a part of objects in the currently displayed area that match the at least one map object type. In addition, when the at least one map object type is multiple map object types, for each map object type, the displaying module 33 may select different quantities or different proportions of objects from all objects matching the map object type in the currently displayed area to display information of the objects. Further optionally, a proportion among quantities of objects selected by the displaying module 33 from all objects matching the map object types in the currently displayed area matches a proportion among quantities of entities, in the at least one entity determined by the first determining module 31, corresponding to the map object types. For example, the at least one entity determined by the first determining module 31 is 10 entities, where at least one map object type corresponding to the 10 entities comprises restaurant, road mark, office building, bank, and store. The second determining module 32 determines that the at least one map object type to which the user is paying attention is map object types ranking in the top three, restaurant, road mark, and office building, where a quantity of gazed-at entities corresponding to the map object type, restaurant, is 5, a quantity of gazed-at entities corresponding to the map object type, road mark, is 4, and a quantity of gazed-at entities corresponding to the map object type, office building, is 3. Optionally, the displaying module 33 displays information of a objects matching the map object type, restaurant, information of b objects matching the map object type, road mark, and information of c objects matching the map object type, office building, and a:b:c=5:4:3.

The other objects are objects that do not match the at least one map object type.

For example, if the at least one map object type is road mark, the displaying module 33 displays information of at least one object matching the map object type, road mark, on the electronic map, and does not display information of any object that does not match the map object type, road mark. Further, if the information is a name, the displaying module 33 displays a name of at least one object matching the map object type, road mark, on the electronic map, and does not display a name of any object that does not match the map object type, road mark.

It is to be noted that, when the information is a name, that the displaying module 33 does not display information of the any other object merely means that the displaying module 33 does not display a name of the any other object, and whether the displaying module 33 displays other information such as a graph or a type icon of the any other object is not limited.

In another optional implementation, the displaying module 33 is specifically configured to: display information of all objects on the electronic map that match the at least one map object type, and display information of a part of other objects.

That is, the displaying module 33 displays information of all objects, in a currently displayed area on the electronic map, that match the at least one map object type, and displays information of a part of other objects, in the currently displayed area on the electronic map, that do not match the at least one map object type.

The other objects are objects that do not match the at least one map object type.

“All” is used in respective of a quantity of objects that match the at least one map object type, and “a part of” is used in respective of a quantity of objects that do not match the at least one map object type. On one hand, a proportion of a part of other objects in all the other objects may be preset, or is determined according to actual distributions of other objects and the at least one object in a currently displayed area on the electronic map. On the other hand, information of which part of the other objects is specifically displayed may be determined according to priorities of the other objects or may be determined according to map layers in which the other objects are located. For example, a currently displayed area on the electronic map comprises 10 objects that match the at least one map object type and 10 other objects that do not match the at least one map object type, and correspondingly, the displaying module 33 displays information of the 10 objects, and displays information of a part of objects in the 10 other objects, for example, information of 5 of the other objects is displayed and information of the other 5 of the other objects is not displayed. Further, if the information is a name, the displaying module 33 displays names of the 10 objects on the electronic map, and displays names of the 5 other objects on the electronic map, and does not display names of the other 5 other objects.

FIG. 2A and FIG. 2B are respectively schematic diagrams of a same displayed area on an electronic map when at least one map object type is restaurant and bank respectively. In FIG. 2A and FIG. 2B, the information are both a type icon. An icon 201 consisting of a knife and a pork in FIG. 2A is a type icon for a restaurant. It can be seen that, a quantity of icons 201 in FIG. 2A is significantly greater than those of other types of type icons. An icon 202 that is a sign “v” in FIG. 2B is a type icon for a bank. It can be seen that, a quantity of icons 202 in FIG. 2B is significantly greater than those of other types of type icons.

In another optional implementation, the displaying module 33 is specifically configured to: display, in an enhancement mode, information of at least one object on the electronic map that matches the at least one map object type, and display information of at least one of other objects in a normal mode.

That is, the displaying module 33 displays, in an enhancement mode, information of at least one object, in a currently displayed area on the electronic map, that matches the at least one map object type, and displays, in a normal mode, information of at least one of other objects in the currently displayed area on the electronic map.

The other objects are objects that do not match the at least one map object type.

In this implementation, optionally, the enhancement mode comprises but not limited to either one of the following: an enlargement mode and a highlight mode. For example, if the at least one map object type is road mark and the enhancement mode comprises an enlargement mode, information of at least one object matching the map object type, road mark, on the electronic map, is displayed enlarged by the displaying module 33, and information of any object that does not match the map object type, road mark, is displayed in a normal size by the displaying module 33. Further, if the information is a name, a name of at least one object matching the map object type, road mark, on the electronic map, is displayed enlarged by the displaying module 33, and a name of any object that does not match the map object type, road mark, is displayed in a normal size by the displaying module 33.

It is to be noted that, in addition to the foregoing three implementations, many other optional implementations for the displaying module 33 also exist, for example, an implementation combining all vs. partial and enhancement mode vs. normal mode, which are not enumerated herein.

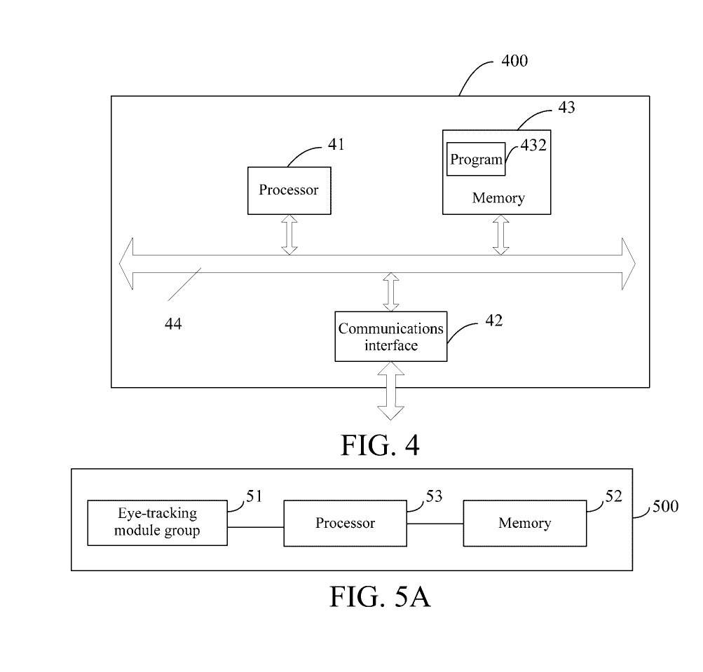

FIG. 4 is a schematic structural diagram according to a second embodiment of an electronic map displaying apparatus provided in the present application. As shown in FIG. 4, the electronic map displaying apparatus (briefly referred to as apparatus hereafter) 400 comprises:

a processor (processor) 41, a communications interface (Communications Interface) 42, a memory (memory) 43, and a communications bus 44, where,

the processor 41, the communications interface 42, and the memory 43 communicate with each other through the communications bus 44.

The communications interface 42 is configured for communication with an external device.

The processor 41 is configured to execute a program 432, and specifically, can perform related steps in the foregoing electronic map displaying method embodiment.

Specifically, the program 432 may comprise program code, where the program code comprises computer operation instructions.

The processor 41 may be a central processor unit CPU, or an application-specific integrated circuit ASIC (Application Specific Integrated Circuit), or one or more integrated circuits configured to implement the electronic map displaying method embodiment.

The memory 43 is configured to store the program 432. The memory 43 may comprise a high-speed RAM memory, and may also comprise a non-volatile memory (non-volatile memory), for example, at least one magnetic disk storage. Specifically, the program 432 may be used to cause the apparatus 400 to perform the following steps:

determining at least one entity at which a user is gazing;

determining, according to at least the at least one entity, at least one map object type to which the user is paying attention; and

displaying emphatically, on an electronic map, information of at least one object matching the at least one map object type.

For specific implementation of the steps in the program 432, refer to the corresponding descriptions of corresponding steps and units in the foregoing electronic map displaying method embodiment, which are not described herein again.

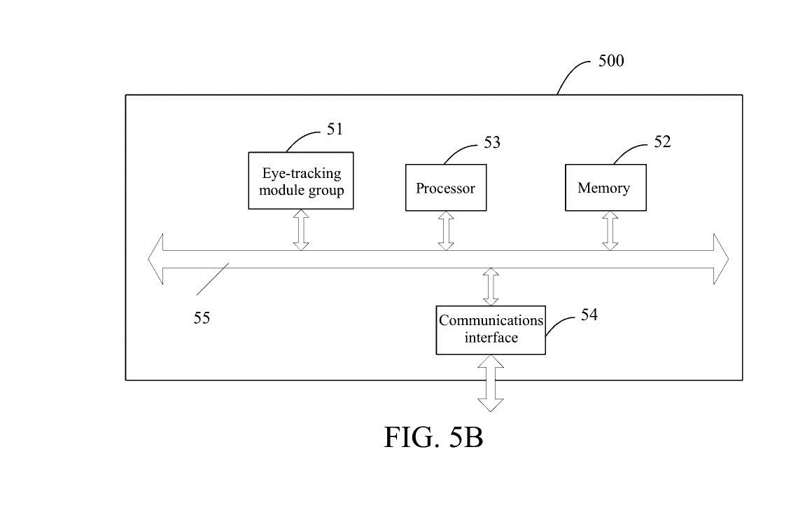

FIG. 5A is a schematic structural diagram according to an embodiment of a vehicular device provided in the present application. As shown in FIG. 5A, the vehicular device 500 comprises:

an eye-tracking module group 51, configured to track eyes of a user;

a memory 52, configured to store instructions; and

a processor 53, configured to execute the instructions stored in the memory 52, where the instructions cause the processor 53 to perform the following operations:

determining, according to at least a tracking result of the eye-tracking module group 51, at least one entity at which the user is gazing;

determining, according to at least the at least one entity, at least one map object type to which the user is paying attention; and

displaying emphatically, on an electronic map, information of at least one object matching the at least one map object type.

In this embodiment, the memory 52 optionally comprises a high-speed random access memory (Random-Access Memory, abbreviated as RAM) memory, and also optionally comprises a non-volatile memory (non-volatile memory), for example, at least one magnetic disk storage.

In this embodiment, the instructions are optionally stored in the memory 52 in a form of an application.

In this embodiment, the processor 53 may be a central processor unit (Central Processing Unit, abbreviated as CPU), or an application-specific integrated circuit (Application Specific Integrated Circuit, abbreviated as ASIC), or one or more integrated circuits configured to perform the foregoing operations. For the foregoing operations performed by the processor 53 caused by the instructions, refer to corresponding descriptions in the foregoing electronic map displaying method embodiment, which are not described herein again.

In an optional implementation, as shown in FIG. 5B, the vehicular device 500 further comprises a communications interface 54 and a communications bus 55. The communications interface 54 is configured for communication with an external device, and communication and control among the eye-tracking module group 51, the memory 52, the processor 53, and the communications interface 54 is performed through the communications bus 55.

For effective effects of this embodiment, refer to corresponding descriptions in the electronic map displaying method embodiment provided in this application.

A person of ordinary skill in the art may be aware that, exemplary units and method steps described in combination with the embodiments disclosed in this specification may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

When the functions are implemented in a form of a software functional unit and sold or used as an independent product, the functions may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and comprises several instructions for instructing a computer device (which may be a personal computer, a server, or a network device) to perform all or a part of the steps of the methods in the embodiments of the present invention. The foregoing storage medium comprises: any medium that can store program code, such as a USB flash drive, a removable hard disk, a read-only memory (ROM), a random access memory (RAM), a magnetic disk, or an optical disc.

The above implementations are only used to describe the present invention, rather than limit the present invention; various alterations and variants can be made by those of ordinary skill in the art without departing from the spirit and scope of the present invention, so all equivalent technical solutions also belong to the scope of the present invention, and the scope of patent protection of the present invention should be defined by claims.

What is claimed is:

1. An electronic map displaying method, wherein the method comprises:
determining at least one entity at which a user is gazing;
determining, according to at least the at least one entity, at least one map object type to which the user is paying attention; and
displaying emphatically, on an electronic map, information of at least one object matching the at least one map object type.

2. The method of claim 1, wherein the determining at least one entity at which a user is gazing comprises:
determining at least one entity at which the user is gazing for a duration exceeding a threshold in a time period.

3. The method of claim 1, wherein the determining, according to at least the at least one entity, at least one map object type to which the user is paying attention comprises:
determining, according to at least the at least one entity, at least one map object type corresponding to the at least one entity; and
determining, according to at least the at least one map object type corresponding to the at least one entity, the at least one map object type to which the user is paying attention.

4. The method of claim 3, wherein the determining, according to at least the at least one map object type corresponding to the at least one entity, the at least one map object type to which the user is paying attention comprises:
determining that the at least one map object type to which the user is paying attention is the at least one map object type corresponding to the at least one entity.

5. The method of claim 3, wherein the at least one map object type corresponding to the at least one entity is multiple map object types; and the determining, according to at least the at least one map object type corresponding to the at least one entity, the at least one map object type to which the user is paying attention comprises:
determining that the at least one map object type to which the user is paying attention is at least one map object type for which a quantity of corresponding gazed-at entities is the greatest in the multiple map object types.

6. The method of claim 1, wherein the displaying emphatically, on an electronic map, information of at least one object matching the at least one map object type comprises:
displaying information of at least one object on the electronic map that matches the at least one map object type, without displaying information of any other object.

7. The method of claim 1, wherein the displaying emphatically, on an electronic map, information of at least one object matching the at least one map object type comprises:
displaying information of all objects on the electronic map that match the at least one map object type, and displaying information of a part of other objects.

8. The method of claim 1, wherein the displaying emphatically, on an electronic map, information of at least one object matching the at least one map object type comprises:
displaying, in an enhancement mode, information of at least one object on the electronic map that matches the at least one map object type, and displaying information of at least one of other objects in a normal mode.

9. The method of claim 8, wherein the enhancement mode comprises either one of the following: an enlargement mode and a highlight mode.

10. The method of claim 1, wherein information of any object of the at least one object comprises any one of the following: a name, a graph, a type icon, and an attribute description.

11. An electronic map displaying apparatus, wherein the apparatus comprises:
a first determining module, configured to determine at least one entity at which a user is gazing;
a second determining module, configured to determine, according to at least the at least one entity, at least one map object type to which the user is paying attention; and
a displaying module, configured to display emphatically, on an electronic map, information of at least one object matching the at least one map object type.

12. The apparatus of claim 11, wherein the first determining module is specifically configured to determine at least one entity at which the user is gazing for a duration exceeding a threshold in a time period.

13. The apparatus of claim 11, wherein the second determining module comprises:
a first unit, configured to determine, according to at least the at least one entity, at least one map object type corresponding to the at least one entity; and
a second unit, configured to determine, according to at least the at least one map object type corresponding to the at least one entity, the at least one map object type to which the user is paying attention.

14. The apparatus of claim 13, wherein the second unit is specifically configured to:
determine that the at least one map object type to which the user is paying attention is the at least one map object type corresponding to the at least one entity.

15. The apparatus of claim 13, wherein the at least one map object type corresponding to the at least one entity is multiple map object types; and the second unit is specifically configured to:
determine that the at least one map object type to which the user is paying attention is at least one map object type for which a quantity of corresponding gazed-at entities is the greatest in the multiple map object types.

16. The apparatus of claim 11, wherein the displaying unit is specifically configured to:
display information of at least one object on the electronic map that matches the at least one map object type, without displaying information of any other object.

17. The apparatus of claim 11, wherein the displaying unit is specifically configured to:
display information of all objects on the electronic map that match the at least one map object type, and display information of a part of other objects.

18. The apparatus of claim 11, wherein the displaying unit is specifically configured to:
display, in an enhancement mode, information of at least one object on the electronic map that matches the at least one map object type, and display information of at least one of other objects in a normal mode.

19. The apparatus of claim 18, wherein the enhancement mode comprises either one of the following: an enlargement mode and a highlight mode.

20. The apparatus of claim 11, wherein information of any object of the at least one object comprises any one of the following: a name, a graph, a type icon, and an attribute description.

21. A vehicular device, wherein the vehicular device comprises:
an eye-tracking module group, configured to track eyes of a user;
a memory, configured to store instructions; and
a processor, configured to execute the instructions stored in the memory, wherein the instructions cause the processor to execute the following operations:
determining, according to at least a tracking result of the eye-tracking module group, at least one entity at which the user is gazing;
determining, according to at least the at least one entity, at least one map object type to which the user is paying attention; and
displaying emphatically, on an electronic map, information of at least one object matching the at least one map object type.
